(19) United States
(12) Patent Application Publication
(10) Pub. No.: US 2021/0016745 A1
(43) Pub. Date: Jan. 21, 2021

(54) MULTIPLE POSITION LOCKING WIPER ARM CONNECTOR

(71) Applicant: Trico Products Corporation, Rochester Hills, MI (US)

(72) Inventors: Alexander KOWAL, Clarkston, MI (US); Nicholas FINATERI, Flint, MI (US)

(21) Appl. No.: 16/979,965

(22) PCT Filed: Mar. 12, 2019
(86) PCT No.: PCT/US2019/021843

§ 371 Date: Sep. 11, 2020

Related U.S. Application Data
(60) Provisional application No. 62/641,480, filed on Mar. 12, 2018.

(51) Int. Cl. B60S 1/34

(52) U.S. Cl. CPC B60S 1/3461; B60S 1/3413

(57) ABSTRACT

A connector for attaching a vehicle wiper arm and blade to a shaft allows the wiper arm to be rotated away from a wiping surface to a service up position. The connector has an internal component which can be rotated to one or more positions within an external component. Further, the connector can be latched into an in-use position

### CROSS-REFERENCE TO RELATED APPLICATIONS

This application claims priority to U.S. Provisional Application No. 62/641,480, filed on Mar. 12, 2018

### BACKGROUND OF THE INVENTION

### 1. Field of the Invention

The present invention relates to an improved connector for a wiper arm and blade, and more specifically a connector for a wiper arm with a configuration that allows for arm rotation and multiple-position locking of the arm for service and the like.

### 2. Description of Related Art

Windshield wipers for use on automotive vehicles have an elongated wiper arm connected to the vehicle for supporting a wiper blade to wipe the surface of the windshield of the vehicle. One end of the wiper arm is fixedly coupled to the vehicle through a splined shaft of a drive motor or linkage assembly, which will drive the wiper arm in a reciprocal motion along the windshield. Commonly, wiper arms include a splined wiper arm head meshed with and coupled to a splined shaft extending from the drive motor or linkage assembly. A spring latch or nut fixedly secures the wiper arm head to the splined shaft for reciprocal motion of the wiper arm in response to reciprocal rotation of the drive shaft.

In certain circumstances, it may be necessary to service the wiper arm or its blade. Wiper blades, for example, are generally designed to be replaced after a period of use. Similarly, it may be necessary to access portions of the wiper arm or its coupling that are not normally accessible or only accessible with difficulty.

The present invention assists in servicing the wiper blade through the use of a connector that allows both a twisting movement and angle changes between an arm and its splined drive shaft.

### SUMMARY OF THE INVENTION

A connector for attaching a vehicle wiper arm and blade to a shaft allows the wiper arm to be rotated away from a wiping surface to a service up position. The connector has an internal component which can be rotated to one or more positions within an external component.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a wiper assembly using a spherical connector according to an embodiment of the present invention;

FIG. 2 is a close-up side view of the spherical connector of FIG. 1 according to an embodiment of the present invention;

FIG. 3 is a side view of the wiper assembly using the spherical connector of FIG. 1, with an increased angle between a wiper arm and a drive motor shaft according to an embodiment of the present invention;

FIG. 4 is a close-up side view of the spherical connector with an increased angle between the wiper arm and the drive motor shaft of FIG. 3 according to an embodiment of the present invention;

FIG. 5 is a close-up perspective view of the interior of the spherical connector of FIG. 4 with the angle between the wiper arm and the drive motor shaft greatly increased according to an embodiment of the present invention;

FIG. 6 is a top perspective view of the spherical connector according to an embodiment of the present invention;

FIG. 7 is a bottom perspective view of the spherical connector of FIG. 6 according to an embodiment of the present invention;

FIG. 8 is a top view of the spherical connector of FIG. 7 according to an embodiment of the present invention;

FIG. 9 is a side view of the spherical connector of FIG. 8 in a service-up position according to an embodiment of the present invention;

FIG. 10 is a bottom perspective view of the spherical connector of FIG. 9 in the service-up position according to an embodiment of the present invention;

FIG. 11 is a close-up top perspective view of the spherical connector of FIG. 10 according to an embodiment of the present invention;

FIG. 12 is a close-up bottom view of the spherical connector of FIG. 11 according to an embodiment of the present invention;

FIG. 13 is a close-up top view of the spherical connector of FIG. 12 according to an embodiment of the present invention;

FIG. 14 is a close-up front view of the spherical connector of FIG. 13 according to an embodiment of the present invention;

FIG. 15 is a cut-out, close-up back view of the spherical connector of FIG. 14 according to an embodiment of the present invention;

FIG. 16 is a top perspective view of an internal component according to an embodiment of the present invention;

FIG. 17 is a bottom view of the internal component of FIG. 16 according to an embodiment of the present invention;

FIG. 18 is a top view of the internal component of FIG. 17 according to an embodiment of the present invention;

FIG. 19 is a side view of the internal component of FIG. 18 according to an embodiment of the present invention;

FIG. 20 is a bottom perspective view of the internal component of FIG. 19 according to an embodiment of the present invention;

FIG. 21 is a top perspective view of the internal component of FIG. 20 according to an embodiment of the present invention;

FIG. 22 is a top perspective view of an external component according to an embodiment of the present invention;

FIG. 23 is another top perspective view of the external component of FIG. 22 according to an embodiment of the present invention;

FIG. 24 is a top view of the external component of FIG. 23 according to an embodiment of the present invention;

FIG. 25 is a side view of the external component of FIG. 24 according to an embodiment of the present invention;

FIG. 26 is a bottom perspective view of the external component of FIG. 25 according to an embodiment of the present invention;

FIG. 27 is a side perspective view of a cut-out section of the external component of FIG. 26 according to an embodiment of the present invention;

FIG. 28 is a side perspective view of a cut-out section of the external component of FIG. 27 according to an embodiment of the present invention;

FIG. 29 is a perspective view of a connector according to an alternate embodiment of the present invention;

FIG. 30 is a top view of the connector of FIG. 29 according to an alternate embodiment of the present invention;

FIG. 31 is a top perspective view of an internal component according to an alternate embodiment of the present invention; and

FIG. 32 is a top perspective view of an external component according to an alternate embodiment of the present invention.

### DETAILED DESCRIPTION OF THE EMBODIMENTS

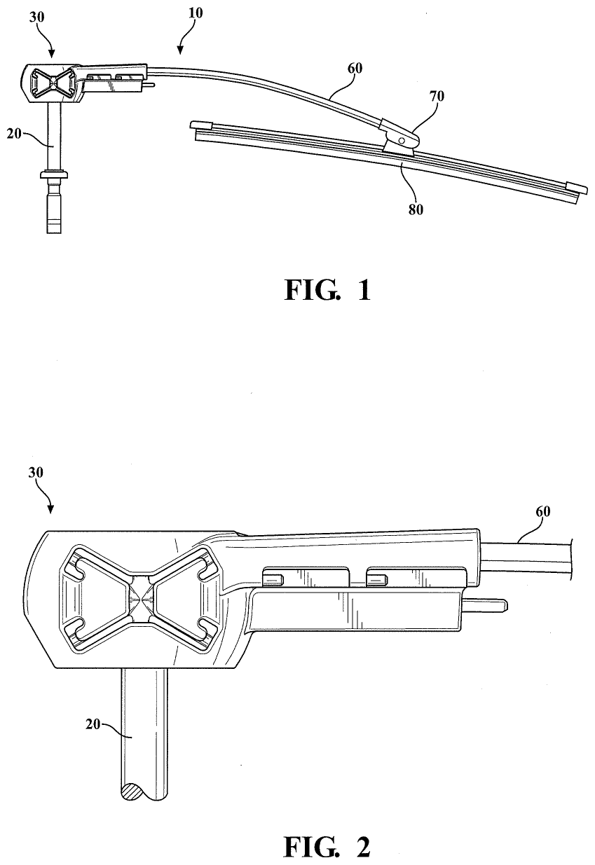

Referring to the Figures, wherein like numerals indicate like or corresponding parts throughout the several views, a windshield wiper assembly is shown in FIGS. 1 and 2 at 10, having a drive motor shaft 20, a spherical connector 30, a wiper arm 60, a wiper connector 70, and a wiper blade 80. The drive motor shaft 20 is configured for connection to a corresponding drive motor or linkage assembly on the vehicle (not shown), which rotates the shaft 20 in opposing directions. The spherical connector 30 is attached to the end of the shaft 20 opposite the drive-motor connection, which provides a nearly 90-degree connection between the drive motor shaft 20 and the wiper arm 60. The spherical connector 30 translates the rotational motion of the shaft 20 to the wiper arm 60, swinging the arm 60 and thus the attached wiper connector 70 and the wiper blade 80 back and forth over a glass windshield surface (not shown). As the wiper blade 80 passes over the glass windshield surface, it pushes water or other precipitation from the windshield surface.

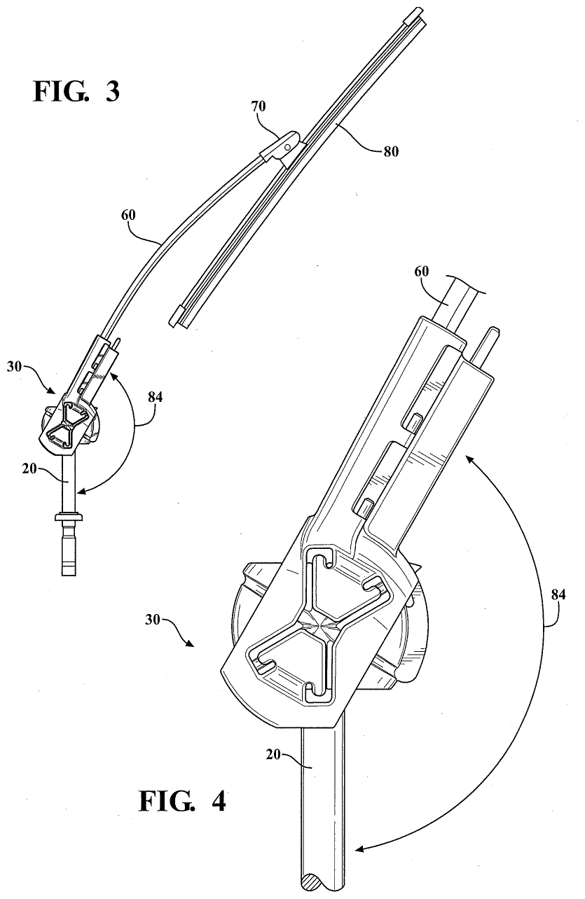

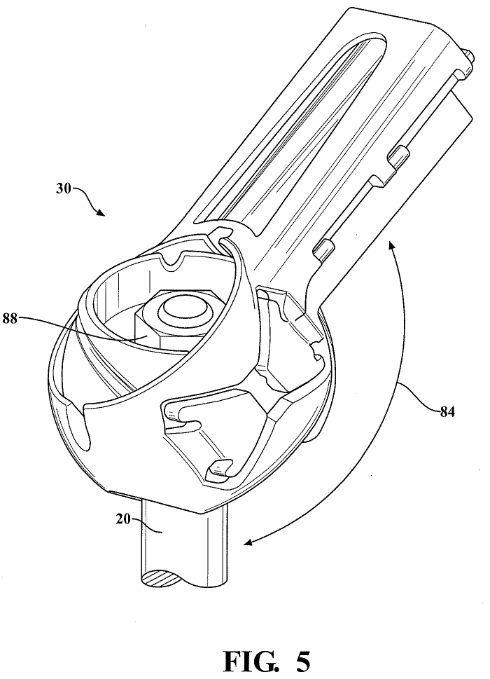

As shown in FIGS. 3 and 4, the angle 84 between the drive motor shaft 20 and the wiper arm 60 can be modified to a greater-than-90-degree angle using the connector 30. On a vehicle, this increased angle between the shaft 20 and the wiper arm 60 pulls the wiper arm 60, the connector 70, and the blade 80 away from the windshield surface. This position provides for improved access for servicing the blade 80, including aiding in the ease of installing a replacement blade. As shown in FIG. 5, the position can also provide access to a fastener 88 that fastens the drive motor shaft 20 to the connector 30. This position is sometimes called the “service-up” position.

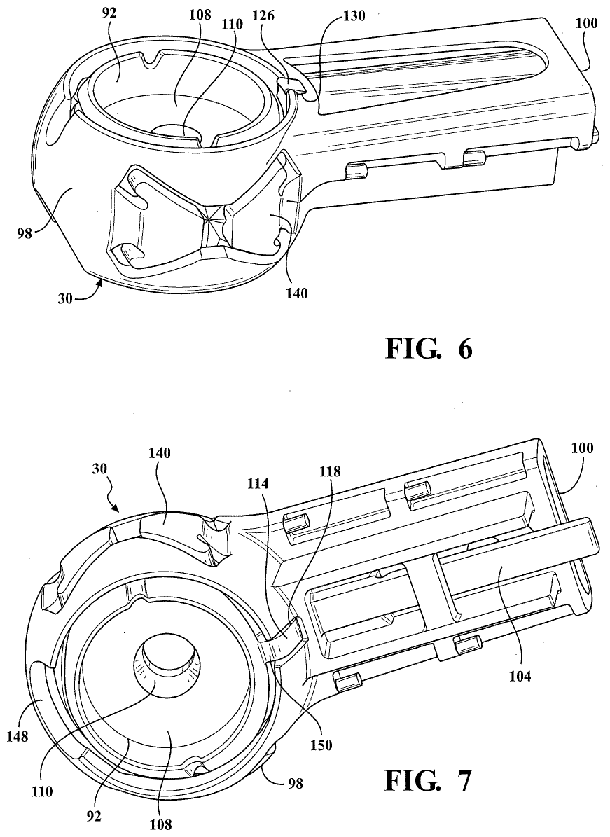

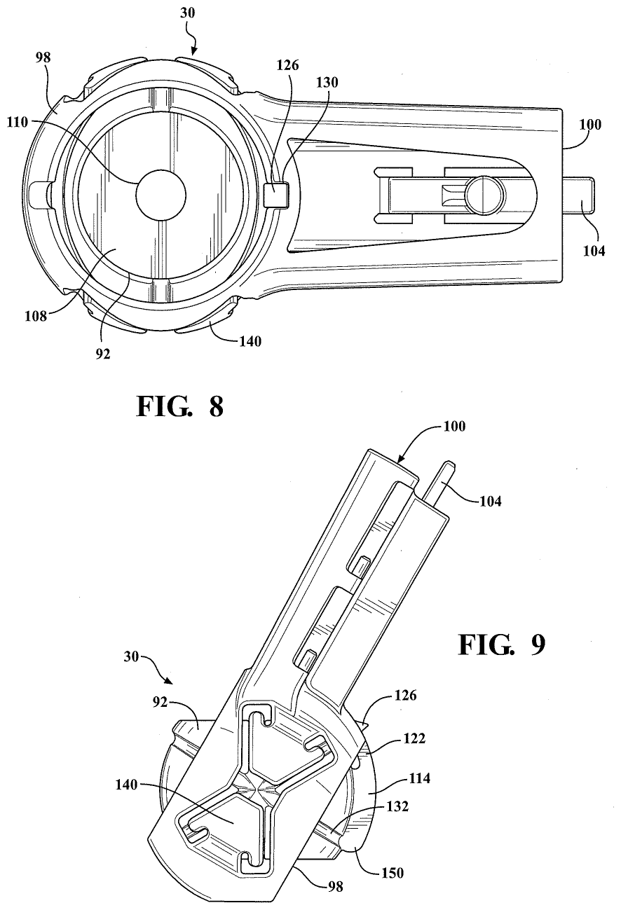

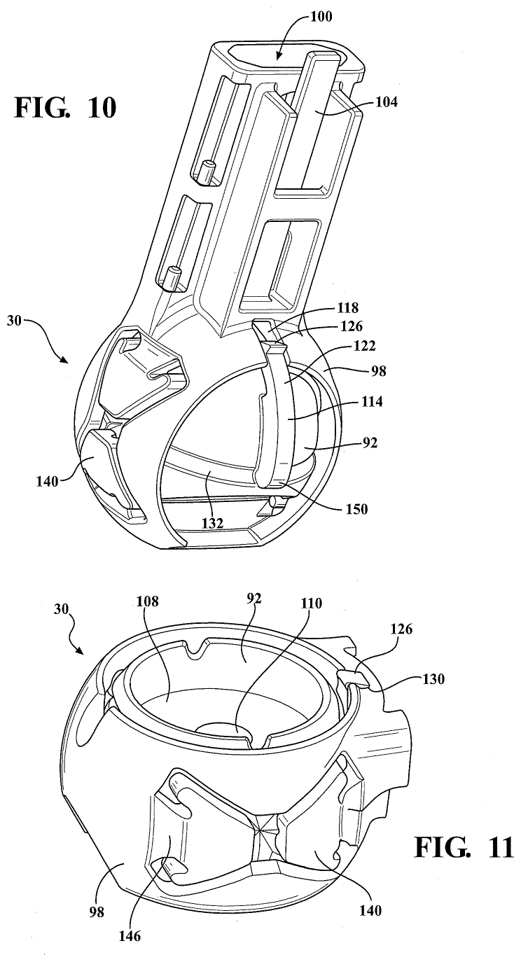

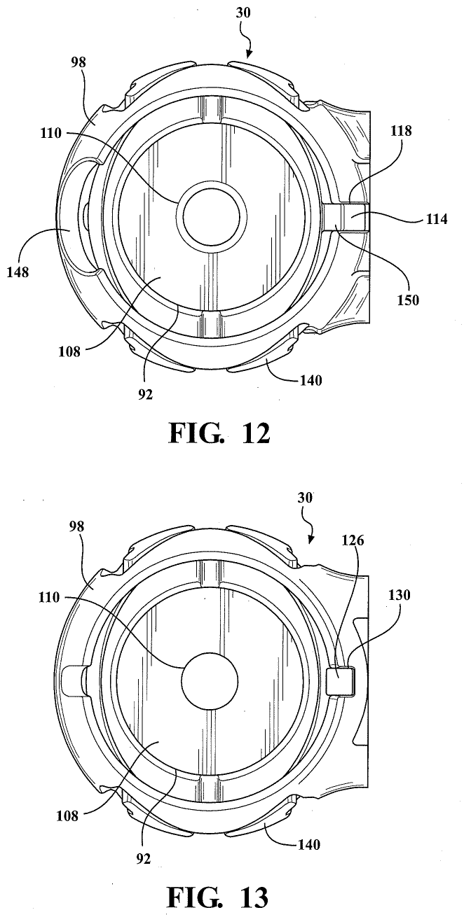

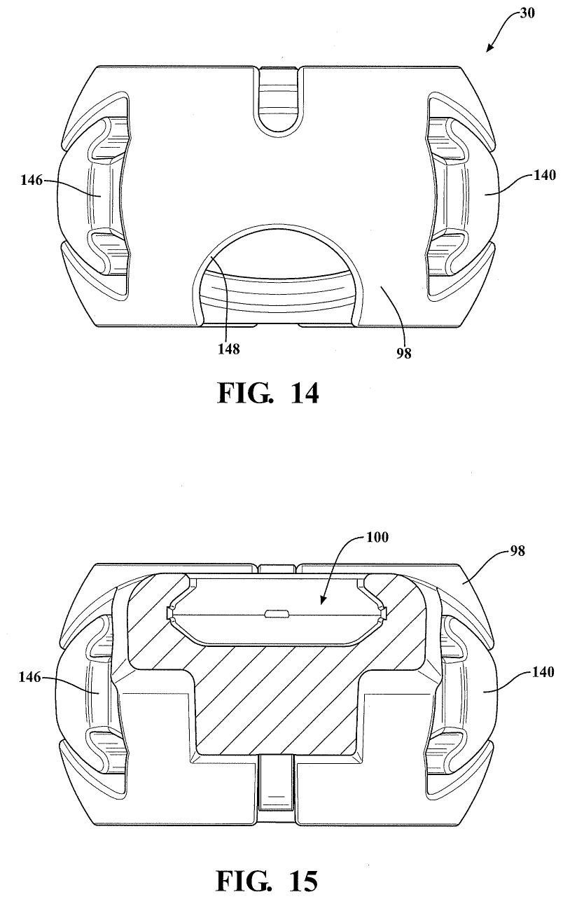

The service-up position is facilitated in the wiper assembly 10 through the use of a connector 30 in accordance with the present invention. FIGS. 6-15 show a closer view of one embodiment of the connector 30, which resembles a ball-and-socket joint, or a cam with multiple locking positions. In this embodiment, the connector 30 is spherical in shape, and includes internal 92 and external 98 spherical components, where the internal component 92 is nested within the external component 98. The external component 98 includes a lateral aperture 100, for insertion and securing of the wiper arm 60. The wiper arm 60 can be secured in position in any number of ways, but is preferably secured using a resilient tab 104, which cooperates with and is inserted into an aperture (not shown) in the wiper arm 60, creating a resistance-fit locking arrangement between the wiper arm 60 and the external component 98. Each of the internal 92 and external 98 components includes structural elements that allow relative rotation between the components 92, 98, as well as positional locking, which, in turn, facilitates the movement of the wiper arm 60 into the service-up position (such as shown in FIGS. 3-5 and 9-10), and the ability to temporarily lock the wiper arm 60 in a desired position. FIG. 6 illustrates the spherical connector 30 in an in-use position.

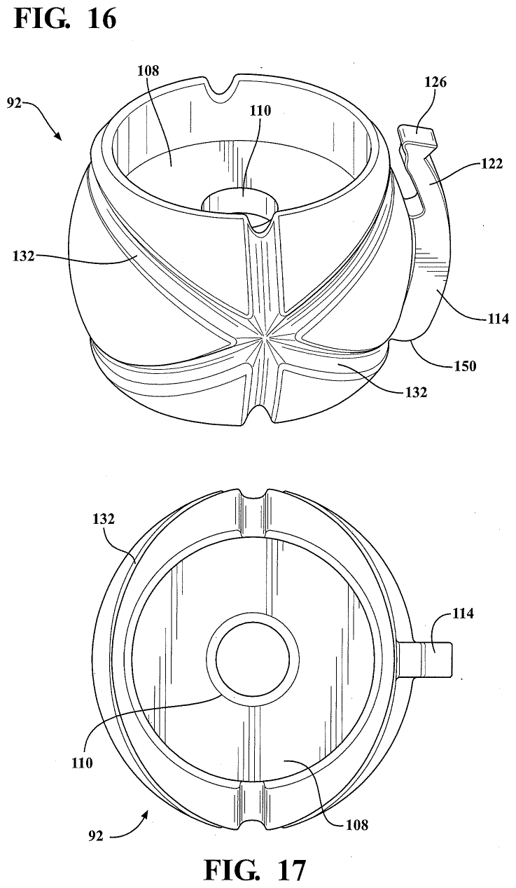

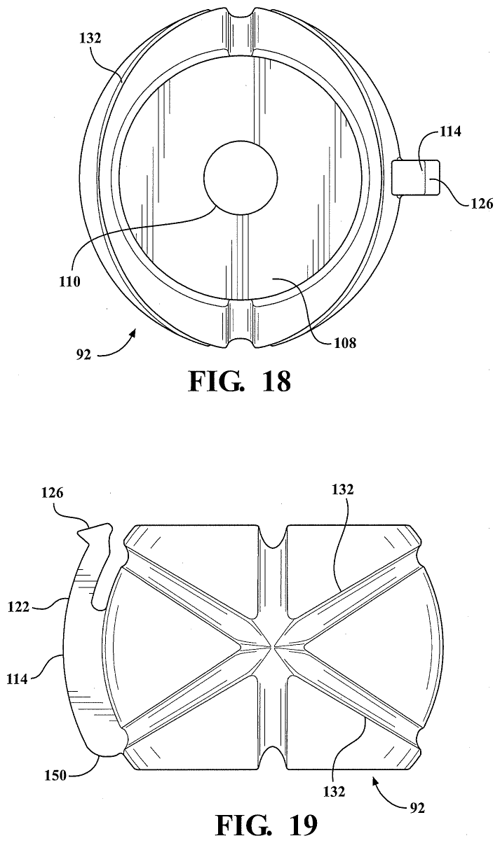

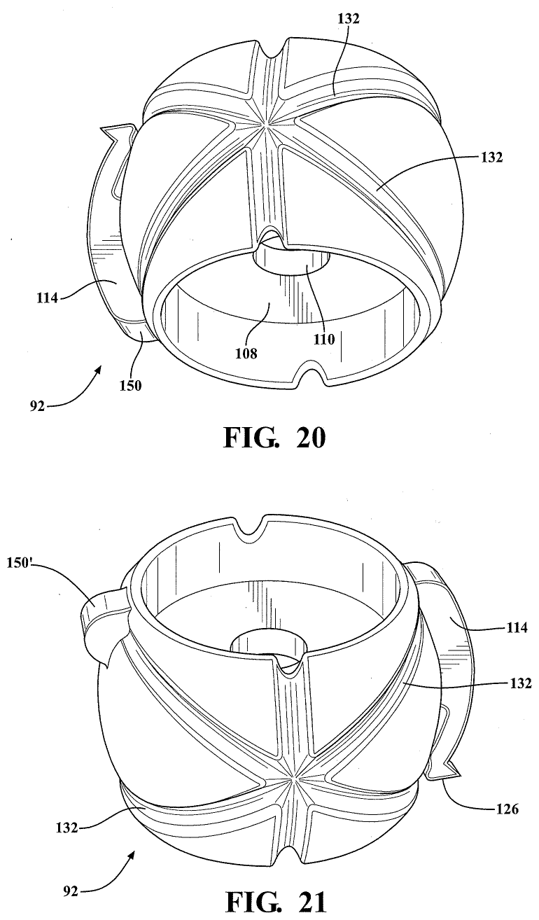

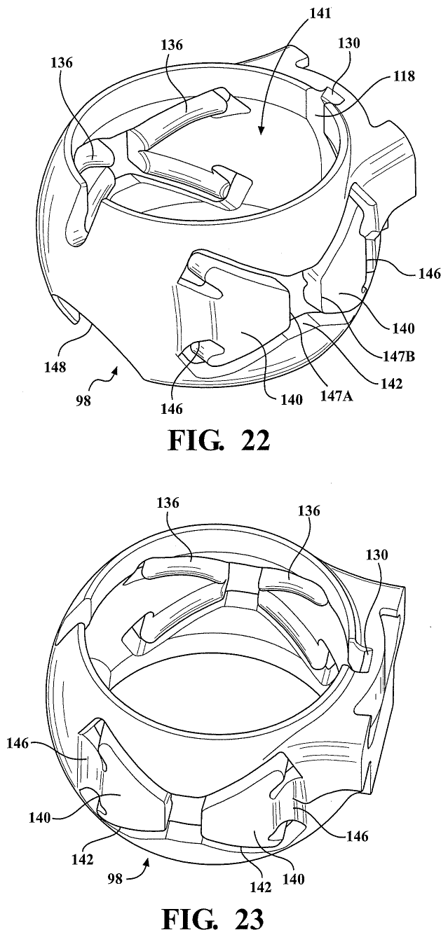

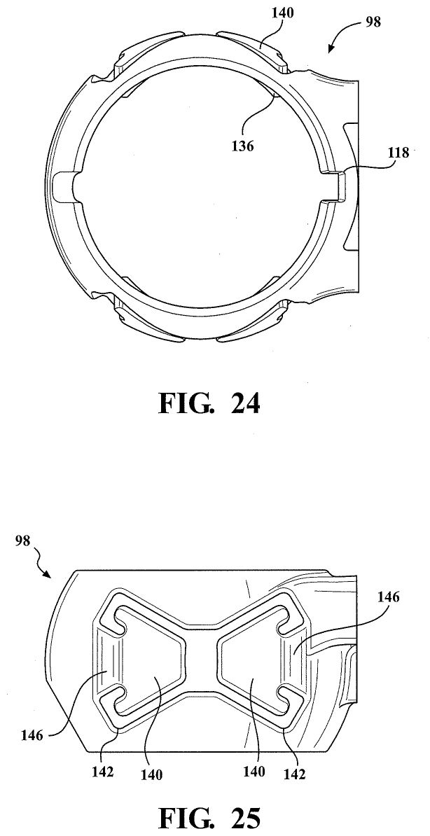

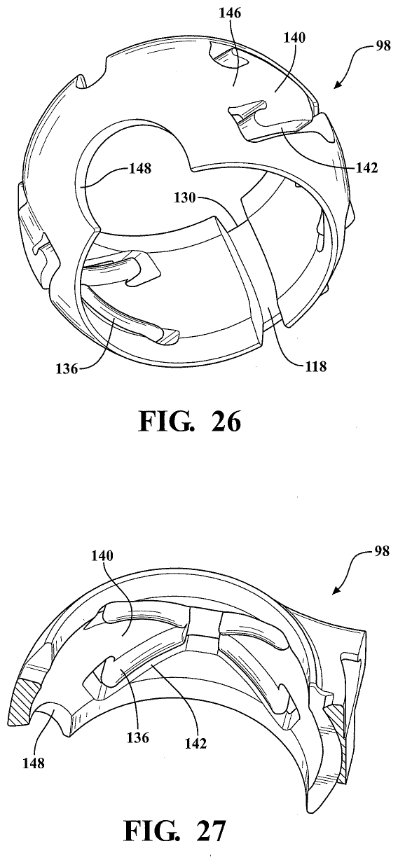

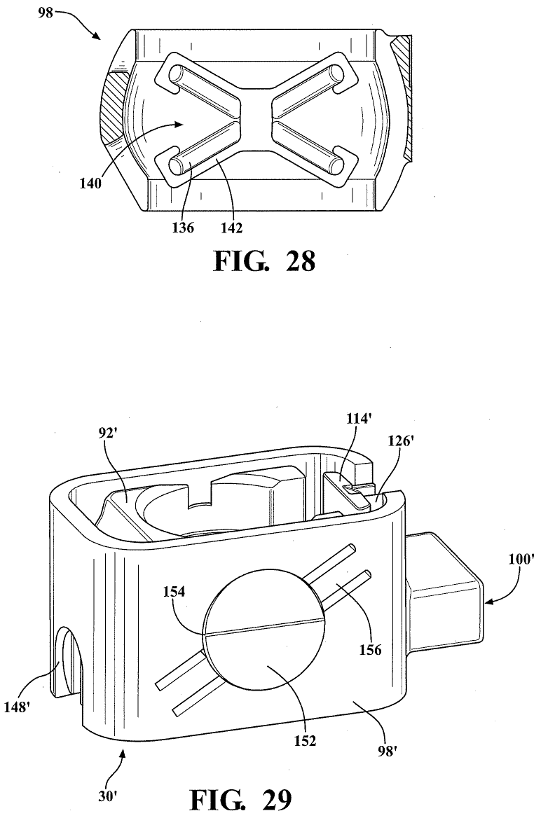

The internal component 92 is shown isolated in FIGS. 16-21, while the external component 98 is shown isolated in FIGS. 22-28. The internal component 92 has an interior body 108 with a planar top and bottom and an aperture 110 through which the drive motor shaft 20 can be inserted and affixed. The drive motor shaft 20 can be affixed in position using a fastener 88 (such as that shown in FIG. 5), which can be located on the top and bottom of the body 108, such as a washer and nut combination, or using a fastener on only one side with another known means on the other side to prevent movement of the connector 30 along the drive motor shaft 20, such as an annular stop, a resistance fit structure, adhesive, or a pin. The body 108 is preferably an integral part of the internal component 92, with sufficient top-down thickness to ensure the drive motor shaft 20 will be retained in the aperture 110 even with the application of outside forces on the connector 30. The body 108 can also be made from a metal annulus, which can be over molded to integrate the metal structure into the internal component 92.

In order to facilitate a change in the angles between the two components 92, 98, and thus to change the angle of the wiper arm 60 relative to the motor drive shaft 20, the internal component 92 includes an anti-twisting embossed groove 114, which cooperates with an alignment channel 118 in the external component 98 to allow lateral rotation of the parts 92, 98 relative to each other without unwanted twisting. The embossed groove 114 includes an extension 122 and a tooth 126 at its upper end, wherein the tooth 126 cooperates with a notch 130 in the external component 98 to prevent unwanted lateral rotation. The connector 30 is in a latched condition and in the in-use position when the tooth 126 is engaged with the notch 130. The connector 30 is in an unlatched condition when the tooth 126 is disengaged from the notch 130. The extension 122 allows the top portion of the embossed groove 114 to flex inward, displacing the tooth 126 from the notch 130, and facilitating lateral rotation of the internal component 92. The internal component 92 can include a more than one embossed groove 114, for example on the opposite side of internal component 92 from embossed groove 114, which would cooperate with another channel 118 in the external component 98 for lateral rotation.

The internal component 98 additionally includes grooves 132 that, when properly aligned, cooperate with embossed grooves 136 on the interior side of the external component 98 to inset the embossed grooves 136 into the grooves 132, retaining them therein. In this configuration, the grooves 132 and embossed grooves 136 assist in preventing rotation of the internal component 92.

The embossed grooves 136 of the external component 98 are located on the interior side of embossed tabs 140 located in the external component 98 and project towards a central cavity 141 in the external component 98. The tabs 140 are formed from female grooves 142, which outline the shape of the tabs 140, which the tabs 140 further include a relief 146 that allows the tabs 140 to work as a flexible living hinge. The hinge function of the tabs 140 allows the tabs 140 to flex outwards so that, when the internal component 92 is rotated laterally along the channel 118 of the external component 98, the tabs 140 can flex outward to allow the embossed grooves 136 to move out of alignment with the grooves 132 on the internal component 92. As shown in FIG. 22, the external component 98 optionally has embossed tabs 140 on opposing sides of the external component 98. Further, the external component 98 optionally has a pair of embossed tabs 140 on each of the opposing sides of the external component 98. Preferably, as shown in FIG. 22, a tip portion 147A of one of the pair of embossed tabs 140 is orientated towards a tip portion 147B of the other one of the pair of embossed tabs 140.

The pattern of the grooves 132 is preferably configured so that, as the internal component 92 continues its lateral rotation, the embossed grooves 136 will again align with another set of the grooves 132, causing a mating arrangement between the embossed grooves 136 and grooves 132, and helping to resist further rotation. The pattern of the grooves 132 is preferably configured so that there are at least two positions in which this mating arrangement between the embossed grooves 136 and grooves 132 happen, including at least a secondary and preferably additional mating arrangements.

The external component 98 further includes a clearance notch 148, which facilitates maximum rotation of the external component 98 by creating an opening to accommodate the drive motor shaft 20. When the external component 98 is rotated towards the service-up position, a portion of the shaft 20 may pass through a channel formed by the clearance notch 148.

Preferably, the grooves 132 are configured so that, when engaged in this secondary position (or tertiary or further position), the angle between the wiper arm 60 and the motor drive shaft 20 is greater than the original angle, and even more preferably at an angle consisting of a service-up position. The grooves 132 and embossed grooves 136 will assist in holding the wiper arm 60 in that position for an extended period of time until, preferably, the internal component 92 is rotated again laterally relative to the external component 98.

Preferably, the internal component 92 includes one or more stoppers 150, 150′ that act to limit the amount of lateral rotation of the internal component 92. The stoppers 150 can be placed on the embossed groove 114, or on the opposite side of the internal component 92, as desired.

The external component 98 assembles over the internal component 92 by flexing and snapping over the internal component 92 allowing the external component 98 to cusp over the internal one 92, working together to provide a connection. This arrangement allows both components 92, 98 to rotate together about the same midpoint. The rotation occurs by overcoming the force of one embossed groove 136 and groove 132 connection moving into the next groove 132.

Both components 92, 98 can twist together around an axis at the same midpoint, and allows for one component 98 to rotate about the other component 92 to change the angle of one component 98 to the other component 92.

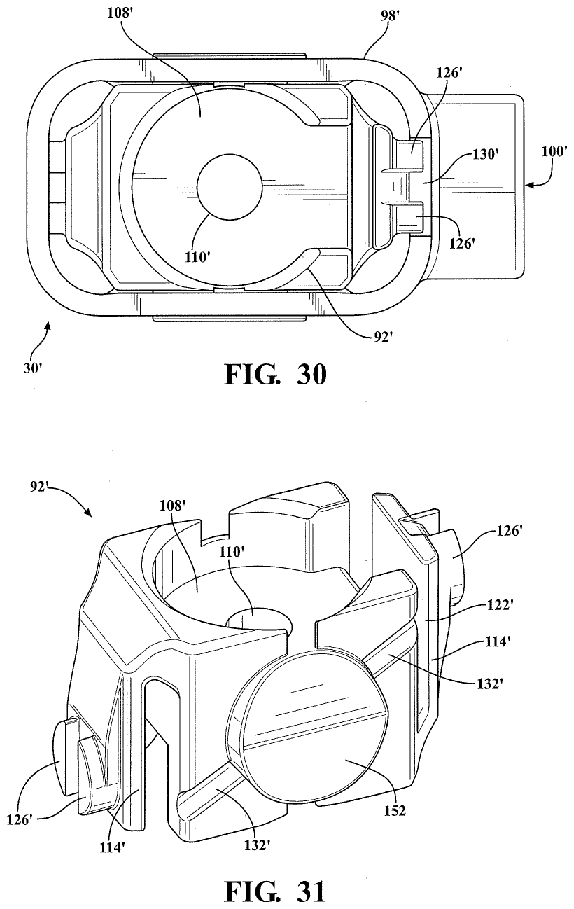

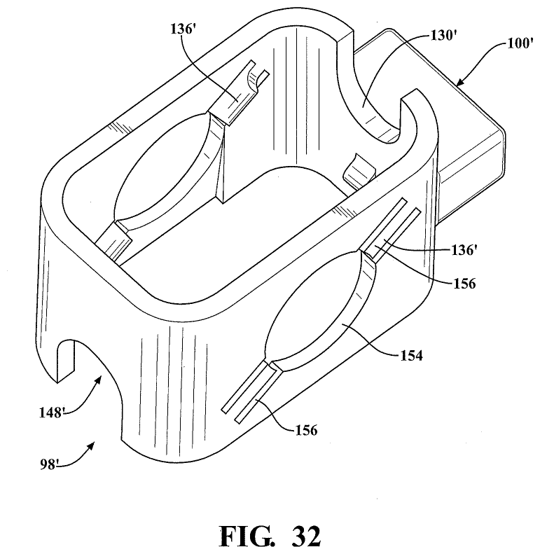

An alternative embodiment of a connector 30′ is shown in FIGS. 29-32, wherein the shape of the connector 30′ is approximately a rectangular prism having curved corners. An internal component 92′ in this configuration includes an embossed groove 114′ wherein an extension 122′ makes up a significant portion of the embossed groove 114′, A tooth 126′ is shown as a split cylindrical shape, although any number of shapes can be used. The extension 122′ facilitates the flexion of the embossed groove 114′ inward so as to move the tooth 126′ out of alignment with a corresponding notch 130′ in an external component 98′. Optionally, the internal component 92′ may have a second embossed groove 114′, a second extension 122′, and a second tooth 126′ on an opposing end of the internal component 92′ as shown in FIG. 31 such that the internal component 92′ can be inserted into the external component 98′ in one or more orientations. The internal component 92′ has an interior body 108′ with a planar top and bottom and an aperture 110′ through which the drive motor shaft 20 can be inserted and affixed.

To facilitate lateral rotation of the internal 92′ and external 98′ components relative to each other, the internal component 92′ additionally includes a pivot structure 152 that cooperates with a pivot opening 154 in the external component 98′. Like the previous embodiment, the external component 98′ additionally includes embossed grooves 136′ that cooperate with grooves 132′ in the internal component 92′, and which prevent lateral rotation of the components 92′, 98′ when in mating engagement. To allow lateral rotation, the embossed grooves 136′ are located on tab cut-outs 156, which are separate structures on the side of the external component 98′ that are attached at one end, but otherwise separated from the component 98′, so that the embossed grooves 136′ can flex outward to facilitate rotation.

Like the previous embodiment, the external component 98′ additionally includes a lateral aperture 100′, for insertion and securing of the wiper arm 60. The external component 98′ further includes a clearance notch 148′, which facilitates maximum rotation of the external component 98′ by creating an opening to accommodate the drive motor shaft 20.

One benefit of a multiple position locking connector is providing access to the wiper arm to replace a wiper blade by rotating the wiper arm away from a wiping surface. A second benefit is a feature allowing the wiper arm to be locked in a service up position and to be locked into an in-use position near the wiping surface. An additional benefit is being able to access a fastener which retains the wiper arm on a drive shaft when the wiper arm is in the in-use position as well as in the service up position.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

We claim:

1. A connector for attaching a vehicle wiper arm and blade to a shaft, said connector comprising:
an internal component having at least one groove on an outer surface of said internal component;
an external component having at least one embossed tab configured for matingly engaging said at least one groove, said external component configured for matingly retaining at least a portion of said internal component within a central cavity passing through said external component;
said external component rotatable about said internal component between a first position wherein said at least one embossed tab is matingly engaged with said at least one groove and a second position wherein said at least one embossed tab is disengaged from said at least one groove.

2. The connector as set forth in claim 1, wherein said internal component having an anti-twisting embossed groove projecting from said outer surface of said internal component, said anti-twisting embossed groove configured to matingly engage with an alignment channel in said external component; and
wherein when said external component is rotated with respect to said internal component between said first position and said second position, at least a portion of said anti-twisting embossed groove is matingly engaged with a portion of said alignment channel.

3. The connector as set forth in claim 2, said anti-twisting embossed groove having a tooth projecting outward from said anti-twisting embossed groove, said tooth configured to matingly engage with a notch in said external component;
wherein said external component is in a latched condition when said tooth is matingly engaged with said notch.

4. The connector as set forth in claim 3, wherein said external component resists rotation about said internal component when said tooth is matingly engaged with said notch and said external component is in said latched condition; and
wherein said external component is rotatable between said first position and said second position when said tooth is disengaged from said notch and said external component is in an unlatched condition.

5. The connector as set forth in claim 4, said internal component having an internal body with a planar top and bottom surfaces and an aperture passing through said internal body between said top surface and said bottom surface;
wherein when said connector is matingly assembled with said shaft by passing a portion of said shaft through said aperture, an upper end of said shaft protruding from said aperture is accessible by a user when said external component is in said first position and in said second position.

6. The connector as set forth in claim 5, wherein said external component having a clearance notch on a lower edge of said external component providing clearance with said shaft when said connector is assembled with said shaft and said external component is in said first position and/or in said second position; and
wherein a portion of said shaft passes through a portion of a channel formed by said clearance notch when said external component is in one of said first position and/or said second position.

7. The connector as set forth in claim 6, said at least one embossed tab having a tab having an embossed groove on an inward side of said at least one embossed tab, and said embossed groove configured to matingly engage with said at least one groove.

8. The connector as set forth in claim 7, wherein said at least one embossed tab having a relief that allows said at least one embossed tab to flex and wherein said relief is a flexible living hinge.

9. The connector as set forth in claim 8, wherein said external component having a lateral aperture for inserting and securing said wiper arm.

10. The connector as set forth in claim 9, wherein said internal component having a generally truncated spherical shape.

11. The connector as set forth in claim 10, said at least one groove comprising a first groove and a second groove, wherein:
when said embossed groove is matingly engaged with said first groove, said external component is retained in said first position; and
when said embossed groove is matingly engaged with said second groove, said external component is retained in a third position; and wherein said first position and said third position are different positions.

12. The connector as set forth in claim 11, wherein said at least one embossed tab has more than one embossed groove.

13. The connector as set forth in claim 12, wherein said external component having at least two embossed tabs with each of said at least two embossed tabs on opposing sides of said external component.

14. The connector as set forth in claim 13, wherein said external component having a pair of embossed tabs on one of said opposing sides.

15. A connector for attaching a vehicle wiper arm and blade to a shaft, said connector comprising:
an internal component having at least one groove on an outer surface of said internal component and having a pivot structure projecting outward from each of opposing sides of said internal component;
an external component having at least one embossed tab configured for matingly engaging said at least one groove, said external component retaining at least a portion of said internal component within a central cavity passing through said external component, and said external component having a pivot opening on each of opposing sides of said external component and rotatably engaging with a respective one of said pivot structures;
said external component rotatable about said internal component between a first position wherein said at least one embossed tab is matingly engaged with said at least one groove and a second position wherein said at least one embossed tab is disengaged from said at least one groove.

16. The connector as set forth in claim 15, said connector having a generally a rectangular prism shape with curved corners.

17. The connector as set forth in claim 16, said internal component having an embossed groove projecting from said outer surface of said internal component, said embossed groove having a tooth projecting outward from said embossed groove and configured to matingly engage with a locking notch in said external component;
wherein said external component is in a latched condition when said tooth is matingly engaged with said locking notch; and said external component is in an unlatched condition when said tooth is disengaged from said locking notch.

18. The connector as set forth in claim 17, said internal component having an internal body with a planar top and bottom surfaces and an aperture passing through said internal body between said top surface and said bottom surface;
wherein when said connector is matingly assembled with said shaft by passing a portion of said shaft through said aperture, an upper end of said shaft protruding from said aperture is accessible by a user when said external component is in said first position and in said second position.

19. The connector as set forth in claim 18, wherein said external component having a clearance notch on a lower edge of said external component providing clearance with said shaft when said connector is assembled with said shaft and said external component is in said first position and/or in said second position; and
wherein a portion of said shaft passes through a portion of a channel formed by said clearance notch when said external component is in one of said first position and/or said second position.

20. The connector as set forth in claim 19, wherein said external component having a lateral aperture for inserting and securing said wiper arm.
